(19) United States
(12) Patent Application Publication
(10) Pub. No.: US 2009/0191333 A1
(43) Pub. Date: Jul. 30, 2009

(54) METHOD FOR PROVIDING OR CORRECTING A FLEXOGRAPHIC PRINTING PLATE, SLEEVE, OR PRECURSOR THEREOF

(76) Inventors: Yariv Y. Pinto, Petach Tikva (IL); David Aviel, Tel Mond (IL)

Correspondence Address: Andrew J. Anderson;Patent Legal Staff, Eastman Kodak Company, 343 State Street, Rochester, NY, 14650-2201, US

(21) Appl. No.: 12/020,616

(22) Filed: Jan. 28, 2008

(51) Int. Cl. B32B 43/00

(52) U.S. Cl. 427/140

(57) ABSTRACT

An uncured laser-engraveable composition can be applied in liquid form, as one or more portions to either: a) a laser-engraveable layer of a laser-engraveable flexographic printing precursor (plate or sleeve), or b) a printing surface of a laser-engraved flexographic printing plate or laser-engraved flexographic printing sleeve. The applied laser-engraveable composition portions can become (for example, by curing) integral parts of the laser-engraveable surface or printing surface so that the applied composition portions can be partially or entirely laser-engraved if desired. This method can be used to provide seamless flexographic sleeves. In addition, it can be used to correct or repair defects, to overwrite an image, or to provide a new laser-engraveable surface in a flexographic printing plate or printing sleeve.

### FIELD OF THE INVENTION

This invention relates to flexography. In particular, it relates to a method of providing laser-engraveable flexographic printing plate precursors and laser-engraveable flexographic printing sleeve precursors. It also relates to a method of correcting or providing additional image areas on already laser-engraved flexographic printing plates or sleeves. In addition, seamless flexographic printing sleeves are provided by the invention.

### BACKGROUND OF THE INVENTION

Flexographic printing plates are known for printing images on surfaces that are either rough (for example, corrugated) or smooth, such as packaging materials, plastic films, wallpaper, and fabrics. The process has mainly been used in the packaging industry where the plates should be sufficiently flexible and the contact sufficiently gentle to print on uneven substrates such as corrugated cardboard as well as flexible materials such as polypropylene film. For flexographic printing, a flexible plate with a relief image is usually wrapped around a cylinder and its relief image is inked up and the ink is then transferred to a suitable printable medium. In order to accommodate the various types of printing media, the flexographic plates should have a rubbery or elastomeric nature whose precise properties can be adjusted for each particular printable medium.

The flexographic printing plate may be prepared by exposing the UV sensitive polymer layer of the plate through a mask in the form of a negative film. The process involves a number of other stages such as a back UV exposure before imaging, a solvent or thermal development stage and heating and further UV exposures. For the purposes of our invention as described below, flexographic plate imaging using a negative film through which the plate is UV exposed and further treated will be termed the “conventional process”. This will distinguish it from digital imaging that may include LAMS (laser ablated mask) and Direct Engraving. In addition, radiation-sensitive elements having a laser-ablatable ablatable element integral to the surface are also known in the art. A relief image can be produced in such elements without the use of a digital negative image or other imaged element or masking device. Also, films with a laser-ablatable mask layer can be formed by first imagewise exposing the film with laser radiation (generally an infrared radiation laser under computer control) to selectively remove the mask layer in the exposed areas. The masking film is then placed in contact with a radiation-sensitive element and subjected to overall exposure with actinic radiation (for example, UV radiation) to cure the radiation sensitive element in the unmasked areas and thus form a negative image of the mask in the element. The film containing the mask layer and the imaged radiation-sensitive element (such as an imaged printing plate precursor) are then subjected to solvent development. The unexposed printing plate areas and the mask layer are completely developed off, and after drying, the resulting imaged element is useful, for example as a flexographic printing plate. Once a plate has been imaged by any of the above methods, there is very little that can be done if an error has crept in to the process or the plate that has been prepared for printing needs correction in any way and it is then necessary to prepare another plate by the long processes of exposure and development as described above.

A simpler way of making a flexographic printing plate is by direct engraving using laser beam ablation, thereby eliminating all need for washing or drying the plate or multiple types of exposure.

Conventionally imaged flexographic plates are generally imaged flat by placing them in a vacuum frame with the negative film in contact. The finished elastomeric plate will then have to be wrapped around the cylinder of the printing press and this results in distortion of the image. Some distortion factor formulae exist for modifying the exposure of the negative to correct for distortion but such methods are inexact. The process of correction is known as “dispro”.

Similarly, where a LAMS plate is imaged on a drum using a laser, ablation occurs and the flexographic plate is then UV-exposed frequently in the flat form and the finished plate is eventually put on the printing press cylinder of a different diameter to the exposure system some image distortion can easily be introduced. In order to avoid this type of distortion, it is possible to image and print on a sleeve that both fits into the imaging system and the printing system. This way the flexographic element is not removed and repositioned during the entire process from before imaging to after printing. This method does not lend itself to conventional exposure where a vacuum would have to be exerted in the round. But it does lend itself to both LAMS and Direct Engraving.

One method for using sleeves is known as plate-to-sleeve. The precursor plate is bonded to an inert sleeve shell and it can then be imaged and further processed without removal from the shell. The most advantageous method in many respects is where the customer receives the sleeve coated with a seamless flexographic plate precursor that can then be imaged and treated and used for printing. Such a method commends itself as several sleeves can have color separated images accurately positioned for preparation of color prints where the colors must be printed accurately one on top of another. This saves the printer considerable time and effort in setting up the print cylinders to produce the same accurate register effect. Also, seamless sleeves can be used to produce an endless continuous pattern. Even where there is a repeat pattern, wastage of material corresponding to the unprintable seam area of the plate can be saved by using a seamless sleeve. Seamless sleeve flexographic plates can be used for printing at faster printing speeds than plates or plates-on-sleeve because at fast speeds, flexographic plates that are bonded to the cylinders so that they can subsequently be removed tend to lift off at the edges when used too fast. A disadvantage of seamless sleeves is that they are generally more expensive than other types of flexographic printing plate precursors and the storage of sleeves requires more space than flat printing plates.

Various means are used for forming the continuous laser-engraveable layer on the substrate or cylinder to form printing sleeves, as described for example in U.S. Pat. Nos. 5,752,444 (Lorig) and 6,866,985 (Lorig et al.). The foil or plate forming the cylinder or sleeve may be closed along its seam edges with an adhesive tape to avoid a gap at the seam. Alternatively, the laser-engraveable layer may be machined or ground with a rotating grinding wheel to insure smoothness of the outer surface for printing.

A flexographic sleeve described by Supachai Theravithayangkura at the 5^{th} Asian Flexo Technical Association & 2^{nd} Asian Gravure Association conference (February 2007) is prepared by closing the seam in a polymer layer in the sleeve using a combination of pressure and heat.

### PROBLEM TO BE SOLVED

In recent years, the quality of flexographic prints (impressions) has improved markedly, but a significant obstacle to flexography gaining a greater share of the print market is the cost of the flexographic printing precursor—whether it is a printing plate precursor or printing sleeve precursor. The precursor may be purchased by either a trade shop that prepares the printable flexographic plate or sleeve for a printer to use or it may be purchased directly by the printer. Once the precursor is received and accepted from the precursor manufacturer, any subsequent damage to the material is no longer the responsibility of the manufacturer and if it then becomes unusable, the trade shop or printer (or the user) has to absorb the cost (loss). If the customer could adequately repair the plate for use it would be a considerable advantage. This situation would also apply to flexographic plates that have been prepared with a slight mistake in the image or where the plates are to be re-used with an addition or subtraction from the original image. As explained above, it is the user who prepares the plate-on-sleeve and it would be advantageous if the user could convert this to a seamless sleeve. This would eliminate the disadvantages and lower the cost of purchasing seamless sleeves from the manufacturer.

### SUMMARY OF THE INVENTION

The present invention overcomes the noted problems and provides with a method of applying an uncured laser-engraveable composition as one or more portions to a printing surface of either:

a) a laser-engraveable flexographic printing precursor, or

b) a laser-engraved flexographic printing plate or laser-engraved flexographic printing sleeve,

so that the one or more applied composition portions become integral parts of the printing surface and can be at least partially laser-engraved.

In addition, this invention provides a method of applying an uncured laser-engraveable composition as one or more portions to:

a) a laser-engraveable layer of a laser-engraveable flexographic printing precursor, or

b) a printing surface of a laser-engraved flexographic printing plate or laser-engraved flexographic printing sleeve,

whereby the one or more applied laser-engraveable composition portions become integral parts of the laser-engraveable surface or the printing surface so that the one or more applied composition portions can be partially or entirely laser-engraved.

In some embodiments of this invention, a method for providing or correcting a flexographic printing plate, comprises:

A) providing:
a) a laser-engraveable flexographic printing precursor having a laser-engraveable layer, or
b) a laser-engraved flexographic printing plate or laser-engraved flexographic printing sleeve having a laser-engraved layer,

B) applying an uncured laser-engraveable composition as one or more selected portions to either the laser-engraveable flexographic printing precursor or laser-engraved flexographic printing plate or printing sleeve to provide laser-engraveable portions in either the laser-engraveable layer or the printing surface of the laser-engraved layer, and

C) after curing, laser engraving at one or more of the applied composition portions.

The present invention provides a simple and cost-effective means for sealing the seams of laser-engraveable flexographic printing sleeve precursors, or for correcting errors or filling cavities in such precursors or already-imaged flexographic printing plates or sleeves. In addition, the present invention provides a simple means for providing new printable or imageable areas or removing unwanted imaged areas on already-imaged flexographic printing plates or sleeves. Furthermore, the invention provides a means of providing correction to imaged plates or sleeves and non-imaged precursors neither of which are imageable by laser engraving but would now have surface areas that can be imaged for correction or can be partially imaged by engraving of the “corrected” areas (even though the plate or precursor itself is non-laser-engraveable).

These advantages are achieved by applying one or more portions of an uncured laser-engraveable composition that is similar in chemical composition to the laser-engraveable layer or printing surface to which it is applied, and curing the applied composition portions so they become integral parts of the printing surface, and in many embodiments, the cured applied portions are essentially no different in laser-engraving properties as the original printing surface. However, in some instances, the applied composition portions may be laser-engraveable while the surface to which they are applied, are not.

Thus, the present invention provides a cost effective means for making or correcting flexographic printing plates or sleeves, or precursors thereof, and especially for seamless flexographic printing sleeve fabrication in a printing shop.

### DETAILED DESCRIPTION OF THE INVENTION

### Definitions

Unless otherwise indicated, the term “uncured laser-engraveable composition” refers to the uncured composition used in the methods of this invention and that is applied to the various precursors or laser-engraved elements. This composition can be in liquid or paste form. In all instances, once cured, the composition can be laser-engraved or printed.

By “ablative”, “laser-engraveable”, or “printed”, we mean that the applied laser-engraveable composition portions can be imaged using a thermal ablating means such as laser radiation that causes rapid local changes in the applied portions thereby causing the component material(s) in the applied portions to be ejected from the surface.

The term “blank” is used in this application to describe a non-imaged printing plate (or printing plate precursor or sleeve precursor).

Unless otherwise indicated, the term “laser-engraveable flexographic printing precursor” refers to laser-engraveable elements prior to imaging. This term includes both “laser-engraveable flexographic printing plate precursors” that are generally flat imageable elements, as well as “laser-engraveable flexographic printing sleeve precursors” that are generally circular imageable elements that are fitted or slid onto a printing cylinder.

The term “laser-engraved flexographic printing plate” refers to the already-imaged flexographic printing plate precursors that can then be used for printing.

The term “laser-engraved flexographic printing sleeve” refers to the already-imaged flexographic printing sleeve precursor that can be used for printing.

By “floor” of the printing plate, we mean the surface at the relief depth in an image area. The floor is not inked-up during printing and thus corresponds to the background areas in a printed impression.

In addition, unless the context indicates otherwise, the various components described herein such as “radiation absorbing compound”, “carbon black”, “elastomeric material”, and similar terms also refer to mixtures of such components. Thus, the use of the article “a” is not necessarily meant to refer to only a single component.

Unless otherwise indicated, percentages refer to percents by dry weight.

For clarification of definitions for any terms relating to polymers, reference should be made to “Glossary of Basic Terms in Polymer Science” as published by the International Union of Pure and Applied Chemistry (“IUPAC”), Pure Appl. Chem. 68, 2287-2311 (1996). However, any definitions explicitly set forth herein should be regarded as controlling.

### METHOD EMBODIMENTS

As noted above, the present invention can be used in several ways. For example, it can be used to change or correct flexographic printing plate precursors or flexographic printing sleeve precursors before they are imaged for the first time. This would be necessary, for instance, if in the course of handling the non-imaged precursor, damage was inflicted on the surface such that the user needed to correct that damage. Damage may be in the form of scoring, any missing parts, or cavities in the surface of the plate. Alternatively, in these embodiments, the invention can be used to affect changes, corrections, or new laser-engraveable or printing regions in already laser-engraved flexographic printing plates or sleeves.

The following representative aspects of this invention are not intended to be limiting:

1) To correct damage, defects, or cavities in cured flexographic printing plate precursors prior to initial laser-engraving.

2) To add additional laser-engraveable regions to cured flexographic printing plate precursors prior to initial laser-engraving.

3) To correct manufacturing defects or cavities in cured flexographic printing sleeve precursors prior to initial laser-engraving.

4) To add additional laser-engraveable regions to cured flexographic printing sleeve precursors prior to initial laser-engraving.

5) To provide seamless laser-engraveable flexographic printing sleeve precursors prior to initial laser engraving by applying the uncured laser-engraveable composition to the seams of user-generated plate-on-sleeves.

6) To correct defects or cavities in laser-engraved flexographic printing plates after an initial laser-engraving.

7) To add additional laser-engraveable image regions to laser-engraved flexographic printing plates after an initial laser engraving, for example by applying the uncured laser-engraveable composition to the engraved area.

8) To correct, erase, or remove all or part of a printing image in laser-engraved flexographic printing plates after an initial laser engraving, for example, by applying the uncured laser-engraveable composition to select regions of a previously laser-engraved printing image.

9) To correct defects or cavities in laser-engraved flexographic printing sleeves after an initial laser engraving, for example by applying the uncured laser-engraveable composition to selected portions of the sleeve printing surface.

10) To add additional laser-engraveable regions to flexographic printing sleeves after an initial laser-engraving.

11) To correct or remove all or part of a printing image in laser-engraved flexographic printing sleeves after an initial laser-engraving.

12) To change the information on an imaged flexographic plate or sleeve by addition of material to provide printing regions, or to provide regions to be imaged or re-imaged.

13) To do any of the above activities on an imaged non-engraveable flexographic plate or sleeve to provide additional printing areas or to provide laser-engraveable areas.

Any or all of these options can be followed by a laser-engraving step that may be the first or only laser-engraving step, or it may be a laser-re-engraving step, of one or more regions of the element.

### Laser-Engraveable Flexographic Printing Precursors and Compositions

The flexographic printing precursors prepared and used in the practice of this invention are cured laser-engraveable materials. Generally laser engraving can be done using carbon dioxide lasers or high-powered lasers emitting in the near infrared.

Particularly of interest are flexographic printing plate precursors that are used to produce plates-on-sleeve for laser-engraving. Such precursors are bonded to inert sleeve materials (that are made, for instance of fiberglass) and the edges are fitted together. However the seams are fitted together, a gap will usually exist between the fitted ends and during printing, this gap will constitute an unprintable area. The present invention overcomes this by filling the gap with an uncured composition that is the same as or similar to that used to make the original flexographic printing precursor and that can be cured using heat. If the seam filling laser-engraveable composition is to be used for imaging as well as printing then although such precursors may be built with multiple layers, the top layer should be where all of the ablation would occur. The filler material of this invention would then have the same or similar composition to this top layer. Suitable laser-engraveable flexographic precursors are those described in WO 2005/084959 (Figov) and U.S. Pat. Nos. 6,223,655 (Shanbaum et al.) and 5,798,202 (Cushner). Particularly useful uncured laser-engraveable seam filling or repair compositions are those comprising a polyurethane polymer, carbon black or another infrared radiation absorbing compound, and silica, but such compositions are most suitable for use with already-cured laser-engraveable flexographic precursors having a similar composition. However, such curable compositions may also contain other additives such as plasticizers, blowing agents, reinforcing agents, thermal stabilizers, antioxidants, hollow spheres, and ablation promoters, all in conventional amounts.

These uncured laser-engraveable compositions are generally made by compounding the solids with suitable diols and isocyanates in the presence of catalysts. The laser-engraveable flexographic precursors and their “repaired” areas may be engraved (imaged) using carbon dioxide lasers or by YAG lasers, fiber lasers, or high powered laser diodes. The presence of carbon black guarantees the absorption of suitable laser power in a large range of wavelengths.

The nature of the flexographic plate or sleeve precursor composition determines the nature of the “repair” material (or laser-engraveable composition). For instance, where the composition is acrylic-based as described in WO 2005/084959 (noted above) and the pre-polymers are cross-linked using a peroxide catalyst, the composition would have the same or similar chemical composition. A repair kit could be delivered to the customer as one or more components that could then be mixed together just prior to application to the flexographic printing precursor or printing plate or sleeve. Polyol and isocyanate components and a suitable catalyst could be kept separate so that the components would not react prior to use.

The properties of the laser-engraveable layer of the precursor and the uncured repair material must be similar after curing so that the surface properties of the printing plate or sleeve are homogeneous. Important properties to be in common with these areas include hardness that can be measured as Durometer hardness, and sensitivity to the laser-engraving energy.

It is also important to have fast curing of the applied uncured composition portions and this may be done by application of heat such as a hot iron pressed onto applied composition portions, or a hot air blower. For treated printing plate precursors, the applied laser-engraveable portion surface must be absolutely coplanar to the rest of the precursor surface as well as becoming an integral part of the flexographic precursor or printing plate upon curing. In order to ensure that this is the case, after application and during the heating/curing process, the applied portions can be covered by a flexible sheet of, for instance, polished metal that is held under tension over the surface to mold them into the desired surface shape (for example curved).

### Uncured Laser-Engraveable Compositions

The uncured laser-engraveable compositions portions used in the practice of this invention are applied to the appropriate precursor surface, or to a flexographic printing plate or sleeve as described above.

The laser-engraveable composition can be cured after application for a sufficient time and at a sufficient temperature to make it an integral part of the laser-engraveable flexographic printing precursor or laser-engraved flexographic printing plate or printing sleeve.

The one or more laser-engraveable composition portions have the appropriate chemical components that enable them to be applied (and cured) to become integral parts of the surface or flexographic image to which they are applied. By “integral” we mean that the applied composition portions have the same or similar laser-engraveable or image-forming properties as the surface to which they are applied. The applied composition portions, once cured, must also adequately adhere to the surface or flexographic image so that they do not flake, peel, or otherwise come off during laser-engraving or printing. In addition, the applied composition portions are laser-engraveable. However, this does not mean that the applied composition portions must have the exact same chemical composition as the laser-engraveable layer or flexographic image to which they are applied.

The curing time and temperature can be adjusted by a skilled worker from knowledge of the properties of specific curable components and/or catalysts or initiators. For example, curing time can be for at least 1 minute and up to 120 minutes. Curing temperature can be at room temperature and up to any temperature that does not degrade the applied composition portions or the surface or flexographic image to which it is applied. The curing may occur in an oven, mold, or other apparatus that is large enough to hold the element being cured. Following curing, the element is brought down to room temperature prior to laser-engraving. Representative curing conditions are described in the Examples below.

Curable components are generally low molecular weight monomers, oligomers, or preformed polymers that can be polymerized, cured, or crosslinked in the presence of free radicals that are generated from exposure to curing heat or irradiation in the presence of an appropriate free radical initiator such as a peroxide. Thus, such thermal initiator systems are those that, upon heating or thermal irradiation, form free radicals. Various initiators are known in the art and include but are not limited to, peroxides, azo derivatives such as 2,2′-azobis (butyronitrole), triazines, and biimidazoles. Useful peroxides initiators are known in the art including compounds that are expressed by the general formula of R¹—O—O—R² wherein R¹ and R² are independently substituted or unsubstituted alkyl or acyl groups, and one of them can be a hydrogen atom. Useful peroxides include but are not limited to the compounds listed in [0052] and [0053] of U.S. Patent Application Publication 2002/0018958 (Nishioka et al.), which information is incorporated by reference. The peroxide initiators can be present in the composition in an amount of at least 0.1 weight % and typically from about 0.5 to about 4 weight %, based on the composition total solids.

Curable components that can be polymerized in the presence of free radicals include but are not limited to, mono-, di-, tri- and higher polyacrylate oligomers or monomers, including urethane acrylates such as urethane diacrylate oligomers, isobornyl acrylate and methacrylate monomers that can be obtained, for example, from Cray Valley. Other useful polymerizable compounds are described on pages 15-16 of WO 2005/074499 (Kanga) that is incorporated herein by reference. These materials can be “cured”, polymerized, or crosslinked using any of a variety of crosslinking agents or initiators, but peroxide initiators are most useful.

Other embodiments can be cured, polymerized, or crosslinked by means other than those involving free radicals. For instance, the laser-engraveable composition can comprise an isocyanate-alcohol and a non-free radical producing catalyst such as dibutyltindilaurate (commercial product is Dabco 33LV that can be obtained from a number of commercial sources including Sigma-Aldrich and Air Products and Chemicals Co.).

The curable laser-engraveable composition portions can be applied at any desired thickness depending upon the particular use to which it is being applied. Any excess composition can be removed quickly after application while the composition is still in fluid form, or any excess cured composition may be removed by grinding, polishing or other mechanical means to provide a smooth surface.

### Imaging Method

The flexographic printing plate precursor or sleeve precursor can be used to provide a corresponding flexographic printing plate or printing sleeve by imaging with suitable imaging ablative (or engraving) irradiation (for example, irradiation in the IR and near IR region a from about 600 to about 1200 nm). Various imaging energies are possible depending upon the imaging laser and apparatus, but generally, imaging is carried out using IR lasers. Obviously, the imaging energy required for desired engraving will depend upon the particular imaging apparatus, the composition and thickness of the laser-engraved layer(s), and whether partial or complete ablation is desired.

In some embodiments, the curable laser-engraveable composition portions are applied to selected regions that have not been previously laser-engraved, and the newly applied laser-engraveable composition portions are then cured and laser-engraved.

In other embodiments, the laser-engraveable composition portions are applied to at least one selected region that has been previously laser-engraved to erase previous engraving and the newly applied laser-engraveable composition portion is then cured and laser-engraved.

As pointed out above, the present invention is not limited to these specific embodiments.

Also, as noted above, laser-engraving can be directed from the top of the upper layer, or if an underlayer is present and transparent, it can be directed from underneath and through the underlayer and into an upper layer.

The resulting laser-engraved printing plates or printing sleeves can then be inked and used in various printing operations under known conditions to print various printable media using known printing equipment.

The following examples are provided to illustrate the practice of the invention but are by no means intended to limit the invention in any manner.

### Materials and Methods:

For the examples below, the following materials were obtained as follows:

BR-403 is an aromatic urethane acrylate that was obtained from Bomar Specialties Co.

Desmodur® N3300A is an isocyanate that was obtained from Bayer.

DBTDL represents dibutyltindilaurate that was obtained from Sigma-Aldrich.

M-5 Cab-O—Sil is fumed silica that was obtained from Cabot.

Mogul L is a carbon black that was obtained from Cabot.

All other components were obtained from conventional commercial sources.

### EXAMPLE 1

A curable laser-engraveable flexographic composition was prepared using the components shown in TABLE I below:

TABLE I

| Component | Amount (wt. %) |
|---|---|
| Desmodur ® N3300A | 15.58% |
| Mogul L | 8.20% |
| M-5 Cab-O-Sil | 8.25% |
| DBTDL | 0.60% |
| Poly(hexamethylene carbonate) diol | 57.38% |
| BR-403 | 10.0% |

A sample of the composition was cured for 1 hour at 60° C. in a mold. A 6 cm×6 cm solid sample was laser-exposed ten times using a Thermoflex drum (1 W diodes) to provide a laser-engraved flexographic image. A drop of the TABLE I laser-engraveable flexographic composition was placed on a small region (portion) of the printing plate image and cured for 1 hour at 60° C. between two mirror-finished aluminum plates. The printing plate was then placed on the Thermoflex drum again and re-exposed ten more times to provide an image in the small cured region. This demonstrates the use of the present invention to provide a laser-imageable region on a previously laser-engraved flexographic printing plate.

### EXAMPLE 2

Another curable laser-engraveable flexographic composition was prepared using the components of TABLE II below.

TABLE II

| Component | Amount (wt. %) |
|---|---|
| Desmodur ® N3300A | 17.31% |
| Mogul L | 9.1120% |
| M-5 Cab-O-Sil | 9.16% |
| DBTDL | 0.66% |
| Poly(hexamethylene carbonate) diol | 63.76% |

A sample of the composition was cured for 1 hour at 60° C. in a mold. A 6 cm×6 cm solid sample was cut diagonally into two parts. A sample of the TABLE II laser-engraveable flexographic composition was applied over the edges (seam) of the adjoining pieces and the two pieces were in contact. The adjoining pieces with the composition over the seam were cured for 1 hour at 60° C. between two mirror-finished aluminum plates that were clamped together. The cured printing flexographic printing plate precursor was then cooled to room temperature and manually polished using a commercial “fine” grit scratch remover. The seamless flexographic printing plate precursor was then laser-exposed twenty times using a Thermoflex drum (1 W diodes) to provide a laser-engraved flexographic image on the seamless flexographic printing plate. This demonstrates the use of the present invention to provide a seamless flexographic printing plate. This embodiment could be modified to provide a seamless flexographic printing sleeve.

The invention has been described in detail with particular reference to certain preferred embodiments thereof, but it will be understood that variations and modifications can be effected within the spirit and scope of the invention.

1. A method of applying an uncured laser-engraveable composition as one or more portions to a printing surface of either:
a) a laser-engraveable flexographic printing precursor, or
b) a laser-engraved flexographic printing plate or laser-engraved flexographic printing sleeve,
so that the one or more applied composition portions become integral parts of the printing surface and can be at least partially laser-engraved.

2. A method of applying an uncured laser-engraveable composition as one or more portions to:
a) a laser-engraveable layer of a laser-engraveable flexographic printing precursor, or
b) a printing surface of a laser-engraved flexographic printing plate or laser-engraved flexographic printing sleeve,
whereby said one or more applied laser-engraveable composition portions become integral parts of said laser-engraveable surface or said printing surface so that said one or more applied composition portions can be partially or entirely laser-engraved.

3. The method of claim 2 wherein said uncured laser-engraveable composition is applied in liquid form to be cured.

4. The method of claim 2 wherein said laser-engraveable flexographic printing plate precursor is an uncured laser-engraveable flexographic printing sleeve precursor and said one or more laser-engraveable composition portions are applied to the seam of said laser-engraveable flexographic printing plate sleeve precursor to provide a seamless laser-engraveable flexographic printing sleeve precursor.

5. The method of claim 2 wherein said one or more uncured laser-engraveable composition portions are applied to said printing surface of said laser-engraved flexographic printing plate to correct a previously laser-engraved printing image.

6. The method of claim 2 wherein said one or more uncured laser-engraveable composition portions are applied to said printing surface of said laser-engraved flexographic printing plate to provide one or more additional laser-engraveable image portions.

7. The method of claim 2 wherein said one or more uncured laser-engraveable composition portions are in liquid form and are cured after application for a sufficient time and at a sufficient temperature to make them integral parts of said laser-engraveable flexographic printing precursor or laser-engraved flexographic printing plate or printing sleeve.

8. The method of claim 2 wherein said uncured laser-engraveable composition has essentially the same composition as said laser-engraveable layer of said laser-engraveable flexographic printing precursor or said printing surface of said laser-engraved flexographic printing plate or printing sleeve.

9. The method of claim 2 wherein said uncured laser-engraveable composition comprises an infrared radiation absorbing compound.

10. The method of claim 2 wherein said uncured laser-engraveable composition comprises a carbon black.

11. The method of claim 2 wherein said uncured laser-engraveable composition comprises a urethane acrylate and a peroxide initiator, or an isocyanate-alcohol and a non-peroxide catalyst.

12. A method for providing or correcting a flexographic printing plate, comprising:
A) providing:
a) a laser-engraveable flexographic printing precursor having a laser-engraveable layer, or
b) a laser-engraved flexographic printing plate or laser-engraved flexographic printing sleeve having a laser-engraved layer,
B) applying an uncured laser-engraveable composition as one or more selected portions to either said laser-engraveable flexographic printing precursor or laser-engraved flexographic printing plate or printing sleeve to provide laser-engraveable composition portions on either said laser-engraveable layer or said printing surface of said laser-engraved layer, and
C) after curing, laser engraving at one or more of said applied composition portions.

13. The method of claim 12 wherein said laser-engraveable flexographic printing precursor is a laser-engraveable flexographic printing sleeve precursor and said one or more uncured laser-engraveable composition portions are applied to the seam of said laser-engraveable flexographic printing sleeve precursor to provide a seamless laser-engraveable flexographic printing sleeve precursor.

14. The method of claim 12 comprising laser engraving said seam as at least one applied composition portion.

15. The method of claim 12 further comprising applying said uncured laser-engraveable composition as selected portions to said laser-engraveable layer of said laser-engraveable flexographic printing sleeve precursor to correct defects or image errors in its flexographic printing surface.

16. The method of claim 12 wherein said uncured laser-engraveable composition is applied as portions said laser-engraved layer of said laser-engraved flexographic printing plate or printing sleeve to correct defects or image errors in its printing surface.

17. The method of claim 12 wherein said laser-engraveable composition is applied as one or more selected portions to a surface that have not been previously laser-engraved, and said newly applied one or more laser-engraveable composition portions are then cured and laser-engraved.

18. The method of claim 12 wherein said uncured laser-engraveable composition is applied as one or more selected portions to a surface has been previously laser-engraved to erase previous engraving and said one or more applied laser-engraveable compositions are then cured and laser-engraved.

19. The method of claim 12 wherein said uncured laser-engraveable composition comprises an infrared radiation absorbing compound.

20. The method of claim 19 wherein said uncured laser-engraveable composition comprises a carbon black.

21. The method of claim 12 wherein said one or more uncured laser-engraveable compositions have essentially the same composition as either said laser-engraveable layer or said laser-engraved layer.

22. The method of claim 12 wherein said uncured laser-engraveable composition comprises a urethane acrylate and a peroxide initiator, or an isocyanate-alcohol and a non-peroxide catalyst.
